(19) United States
(12) Patent Application Publication
(10) Pub. No.: US 2013/0312566 A1
(43) Pub. Date: Nov. 28, 2013

(54) IMPLEMENT AND OPERATOR CONTROL FOR USE WITH SAME

(71) Applicant: Chadwick A. Shaffer, Oakdale, MN (US)

(72) Inventor: Chadwick A. Shaffer, Oakdale, MN (US)

(21) Appl. No.: 13/480,695

(22) Filed: May 25, 2012

(51) Int. Cl. G05G 1/04

(52) U.S. Cl. 74/490.14

(57) ABSTRACT

A power equipment unit such as an electric snowthrower, lawn mower, or the like, and a control system for use with the same. In one embodiment, a key is provided that functions as both a conventional removable key, and also as a push button mechanism to provide dual actuation functionality for a lever of the control system.

Embodiments of the present invention relate generally to powered ground-engaging implements, and, more particularly, to controls for use with the same.

### BACKGROUND

Outdoor power equipment units such as walk-behind lawn mowers and snow throwers are generally known in the art. Such equipment typically includes a ground-engaging implement having a handle extending upwardly and rearwardly from the implement. Attached to the handle is one or more controls configured for manipulation by an operator. For instance, a lever (e.g., bail) may be attached at or near the upper end of the handle. The bail may pivot between inoperative and operative positions, whereby actuation of the implement occurs upon movement of the bail to the operative position. Stated alternatively, the implement (e.g., a rotatable cutting blade of a lawn mower or an impeller of a snow thrower) may be energized when the bail is in the operative position, and de-energized when the bail is in the inoperative position.

Often, an interlock or deadman switch is also included and is first actuated before movement of the bail will effect actuation of the implement. Such a “dual-action” requirement may reduce the chances that the operator inadvertently energizes the implement. In some electrically-powered implements, for example, a switch is provided that can be actuated with one hand, while a second hand moves the bail from the inoperative to the operative position.

As an additional safety measure, some power equipment units may further incorporate a separate, removable key. The key is generally inserted and rotated to a preselected position before the activation switch and/or the bail become functional.

### SUMMARY

The present invention may overcome these and other issues with known implements by providing, in one embodiment, a power equipment unit having a ground-engaging implement and a handle having a first end attached to the implement and a second end configured to cooperate with an operator. A lever may be provided and pivotally attached to the handle near the second end, the lever being pivotable between an inoperative position and an operative position. A key may also be provided and removably receivable within an opening located proximate the second end of the handle, the key configured to move within, and along an axis of, the opening, between: an off position, wherein movement of the lever between the inoperative and operative position has no effect on the implement; and an on position, wherein movement of the lever between the inoperative and operative position results in actuation of the implement.

In another embodiment, a power equipment unit is provided that includes a ground-engaging implement and a handle having a first end attached to the implement and a second end configured to cooperate with an operator. A control housing may also be provided and attached to the handle near the second end. The control housing includes a switch selectively configurable between: a normally open state corresponding to a de-energized state of the implement; and a closed state corresponding to an energized state of the implement. A lever may be pivotally attached to the handle near the second end, wherein the lever is pivotable between at least an inoperative position and an operative position. A removable key may also be provided and configured to be positioned within an opening of the control housing. The key is configured to move within, and along an axis of, the opening, between: an off position, wherein movement of the lever from the inoperative position to the operative position has no effect on the switch; and an on position, wherein movement of the lever from the inoperative position to operative position results in manipulation of the switch from the open state to the closed state.

In yet another embodiment, a power equipment unit is provided that includes an electrically powered, ground-engaging implement, and a handle having a first end attached to the implement and a second end configured to cooperate with an operator. A control housing may be attached to the handle near the second end, wherein the control housing includes a switch selectively configurable between: a normally open state corresponding to a de-energized state of the implement; and a closed state corresponding to an energized state of the implement. A lever may be pivotally attached to one or both of the handle and the control housing, the lever pivotable between an inoperative position and an operative position. A removable key configured to be positioned within an opening of the control housing may also be provided, wherein the key is configured to move within, and along an axis of, the opening between: an off position, wherein movement of the lever from the inoperative position to the operative position is isolated from the switch; and an on position, wherein movement of the lever from the inoperative position to the operative position results in manipulation of the switch from the open state to the closed state.

The above summary is not intended to describe each embodiment or every implementation of the present invention. Rather, a more complete understanding of the invention will become apparent and appreciated by reference to the following Detailed Description of Exemplary Embodiments and claims in view of the accompanying figures of the drawing.

### BRIEF DESCRIPTION OF THE VIEWS OF THE DRAWING

The present invention will be further described with reference to the figures of the drawing, wherein:

FIG. 1 illustrates a power equipment unit, e.g., an electric snowthrower (solid lines) or lawn mower (broken lines), having a handle and lever (e.g., bail) control system in accordance with embodiments of the present invention;

FIG. 2 is an enlarged perspective view of an upper portion of the handle and bail control system of FIG. 1, wherein a key of the bail control system is shown removed from a control housing;

FIG. 3 is a perspective view like that of FIG. 2, but with the key shown inserted into the control housing and in a first or “off” position;

FIG. 4 is a perspective view like that of FIG. 3, but with the key shown displaced to a second or “on” position and a lever (e.g., bail) of the control system shown in an inoperative position;

FIG. 5 is a perspective view like that of FIG. 4, but with the key shown in the on position and the bail shown in an operative position;

FIG. 6 is an exploded view of the control housing of the control system of FIG. 2 in accordance with one embodiment of the invention;

FIG. 7 is a perspective view of the key of FIG. 2;

FIG. 8 is an exploded perspective view of a pivot member and a switch actuator of the control system of FIG. 6 in accordance with one embodiment of the invention;

FIG. 9 is a perspective view of a first side of the exemplary pivot member of FIG. 8;

FIG. 10 is a perspective view of a second side of the exemplary pivot member of FIG. 8;

FIG. 11 is a section view of the exemplary control housing of FIG. 2 with the key shown in the off position;

FIG. 12 is a section view like that of FIG. 11, but with the key shown in the on position;

FIG. 13 is a perspective view of the control housing of FIG. 2 with one side removed and the key shown in the off position;

FIG. 14 is a perspective view of the control housing (with one side removed) and the bail with the key shown in the off position and the bail shown in the operative position;

FIG. 15 is a view similar to FIG. 14 but with the key removed for clarity and the control system configured as if the key were placed in the on position prior to the bail being moved to the operative position;

FIG. 16 is a side view of the control housing (with one side again removed) and bail, wherein the key is again removed but the control system configured as if the key were in the on position and the bail in the inoperative position; and

FIG. 17 is a side view like that of FIG. 16, but with the bail shown in the operative position.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments of the invention. The lack of illustration/description of such structure/components in a particular figure is, however, not to be interpreted as limiting the scope of the invention in any way.

### DETAILED DESCRIPTION OF EXEMPLARY EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention.

Embodiments of the instant invention are directed to power equipment units (e.g., walk-behind, electrically powered ground-engaging implements) having a handle and control system both configured to cooperate with an operator. For instance, embodiments of the instant invention may be directed to lever-actuated control systems and implements incorporating the same. While described and illustrated herein as a bail (a lever pivotable about a horizontal axis (that is transverse to a direction of implement travel) by either or both hands), such a configuration is not limiting. For example, embodiments wherein the lever is configured for manipulation by only one of the hands, and/or where the lever pivots about a different axis (e.g., an axis normal to a plane of the handle) are also contemplated within the scope of the invention.

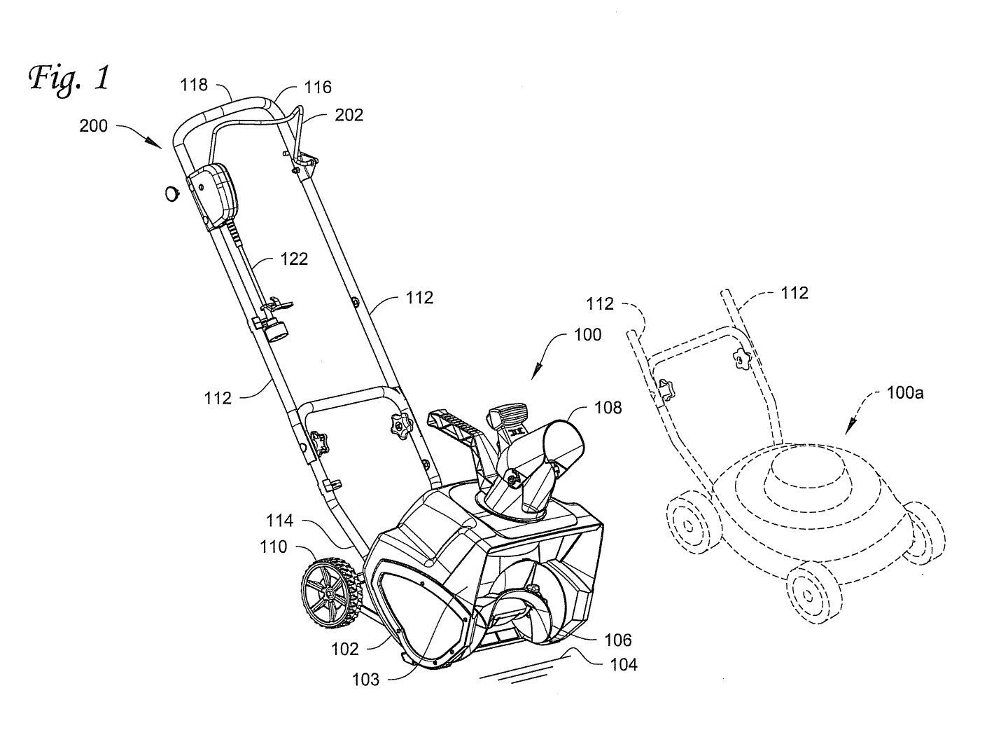

It is noted that the terms “comprises” and variations thereof do not have a limiting meaning where these terms appear in the accompanying description and claims. Further, “a,” “an,” “the,” “at least one,” and “one or more” are used interchangeably herein. Moreover, relative terms such as left, right, front, forward, rear, rearward, top, bottom, side, upper, lower, above, below, horizontal, vertical, and the like may be used herein and, if so, are from the perspective observed in the particular figure, or as observed when the implement is in its typical operating orientation (see, e.g., FIG. 1). These terms are used only to simplify the description, however, and not to limit the scope of the invention in any way.

With reference to the drawings, wherein like reference numerals designate like parts and assemblies throughout the several views, FIG. 1 illustrates a perspective view of a power equipment unit having a powered, ground-engaging implement (e.g., electric snowthrower 100) in accordance with one embodiment of the invention. While described herein with application to an electrically powered snowthrower, embodiments of the present invention are equally applicable to other power equipment, e.g., other electric and non-electric walk-behind or ride-behind equipment and associated implements. For instance, control systems in accordance with embodiments of the present invention may also find application to electric lawn mowers such as mower 100a shown in broken lines in FIG. 1.

The illustrative snowthrower 100 may include a powerhead 102 capable of clearing snow from a ground surface 104. As is known in the art, the powerhead may be a single stage device that includes a housing 103 in which a powered, rotating impeller 106 is mounted. The impeller 106 is typically configured to rotate about an axis that is transverse to the direction of implement travel. Power to the impeller 106 may be provided by an electric motor (not shown) also mounted to or within the housing 103.

Snow collected by the impeller 106 may be ejected from the housing through an adjustable discharge chute 108. Thus, snow removed from the ground surface 104 may be dispersed, via the chute 108, to a location lateral to the snowthrower 100.

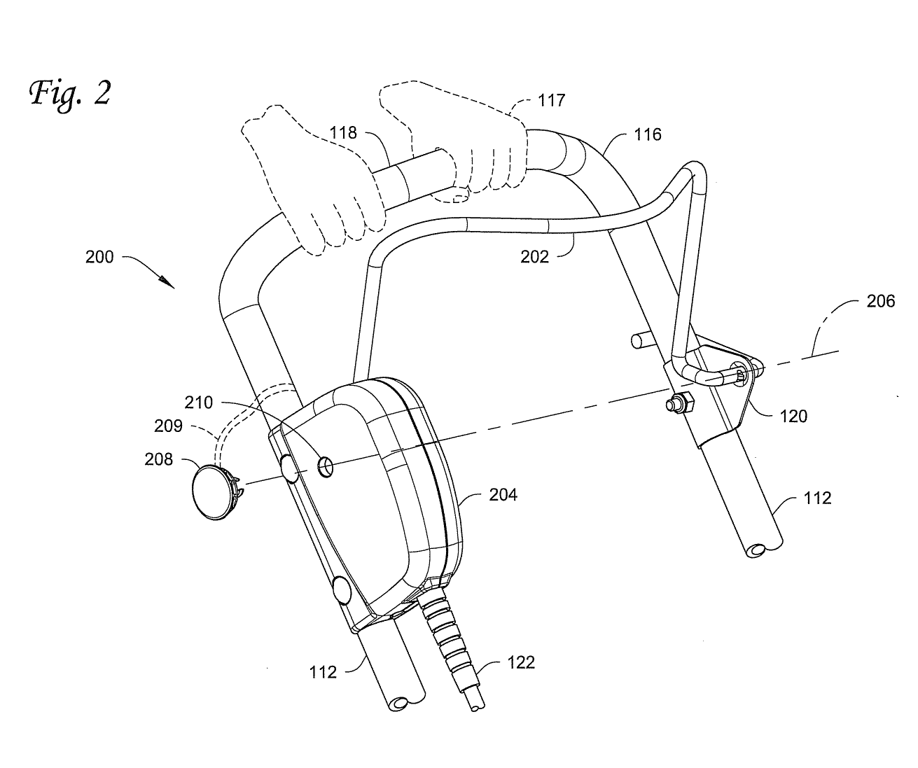

In some embodiments, the impeller 106 rotates in a direction that assists with propelling the implement forward. To assist with supporting the housing 103 during operation, two passive wheels 110 (only right wheel visible in FIG. 1) may be provided on a rear side of the housing 103. A handle 112, having a first end 114 attached to the implement (i.e., to the powerhead 102), may extend upwardly and rearwardly as shown in FIG. 1 where it may terminate at a second end 116. The second end 116 may be configured to cooperate with hands of an operator 117 (see FIG. 2) standing behind the snowthrower 100.

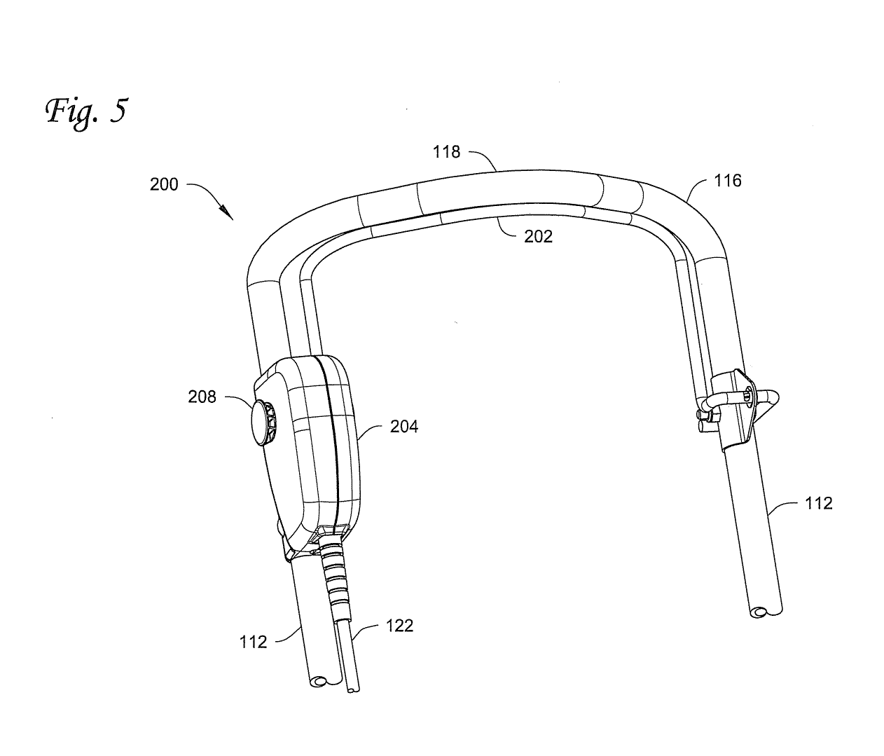

The handle may be generally U-shaped to provide a transverse operator gripping area 118 at the second end 116 as shown in FIG. 1. A control system, e.g., lever control system 200, may be attached to the handle at or near the second end 116. The control system may provide one or more manipulatable members that control operation of the snowthrower. For example, in the illustrated embodiment, the control system 200 includes a lever (an exemplary embodiment of which is described and illustrated herein as a movable wireform bail 202), pivotally attached to the handle near the second end 116. The bail 202 may pivot between: a first or inoperative position (shown in FIG. 1), which corresponds to an inoperative mode of the powerhead; and a second or operative position (see, e.g., FIG. 5), which corresponds to an operative mode of the powerhead. However, as stated elsewhere herein, the bail could be configured as most any type of pivoting lever without departing from the scope of the invention.

FIG. 2 is an enlarged view of the control system 200 and the second end 116 of the handle 112. As shown in this view, the bail 202 may have a shape that generally corresponds to a shape of the gripping area 118 when the bail is in the operative position (see, e.g., FIG. 5). The bail 202 may pivotally attach to the handle 112 via a bracket 120 on one side of the handle, and be pivotally receivable within a control housing 204 on an opposite side (the housing itself being attached to the handle 112 (e.g., near the second end)). The bracket 120 and control housing 204 may be configured to permit pivoting of the bail 202 about a transverse pivot axis 206 as shown in FIG. 2.

The control housing 204, as further described below, may contain various electrical components configured to selectively route power from an external source (e.g., a short electrical power cord 122 connected, via an extension cord (not shown), to a conventional electrical outlet (also not shown)) to the electric motor of the implement. While shown as utilizing external power, those of skill in the art will realize that embodiments wherein the power source is located on-board (e.g., battery-powered) are also contemplated.

The control system 200 may further include a key 208. The key 208 may interact with an opening 210 (e.g., be removably receivable therein) fainted in the control housing 204 to selectively allow implement actuation. For example, when the key 208 is detached from the housing 204 as shown in FIG. 2, implement actuation is not permitted. That is, movement of the bail 202 to the operative position does not result in implement actuation. A lanyard 209 may optionally be provided to secure the key to the handle.

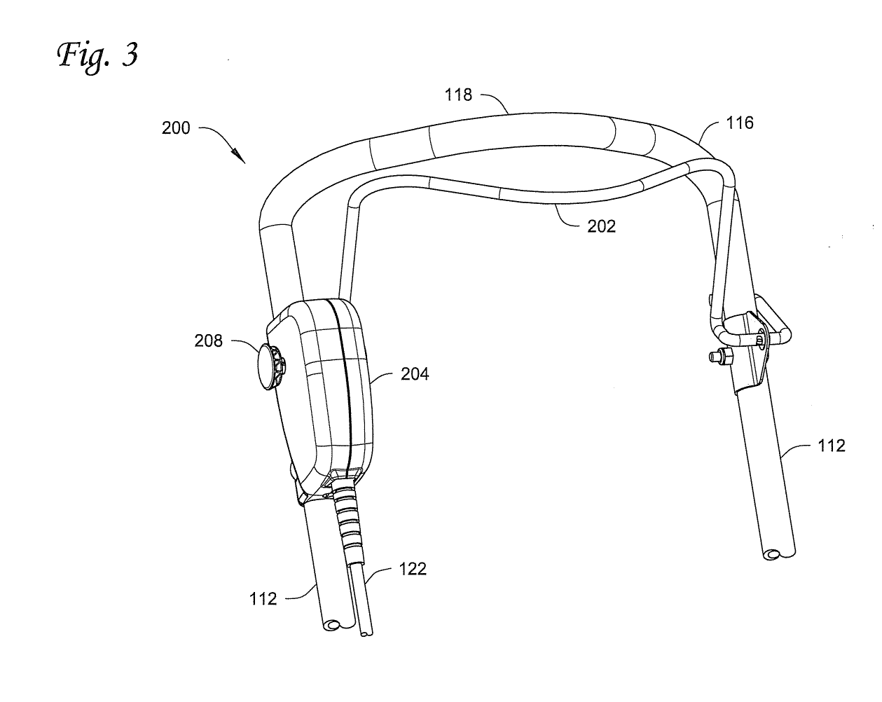

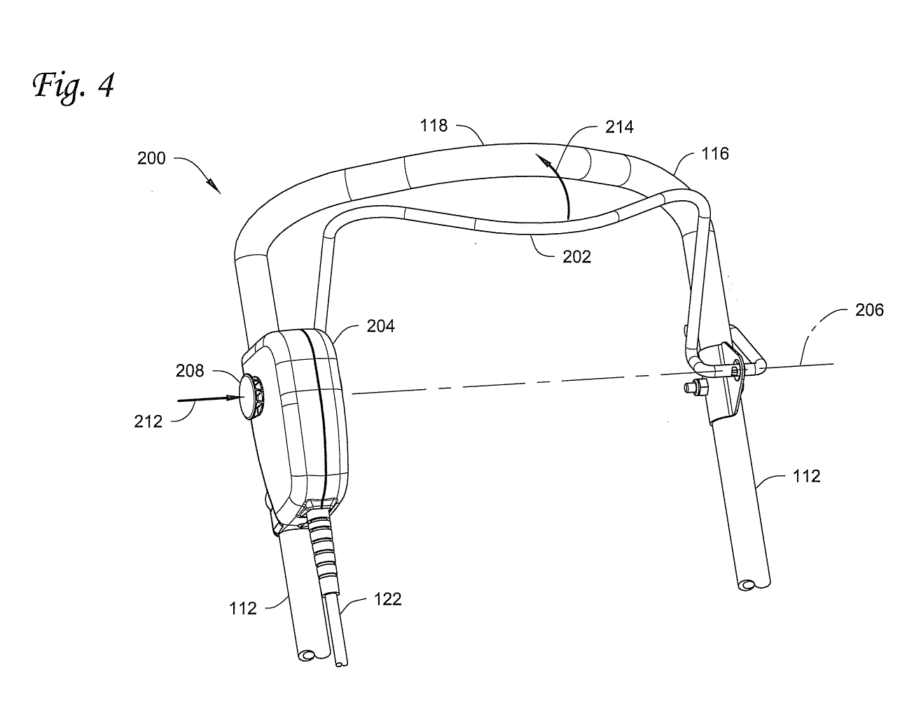

Prior to implement operation, however, the key 208 may be inserted into the opening 210 as shown in FIG. 3. Once so inserted, the key 208 may be retained within the opening 210 as shown. The key may also be movable within, and along an axis of, the opening between: a first or “off” position as shown in FIG. 3; and a second or “on” position as shown in FIG. 4. The key 208 may be biased toward the off position by a biasing member as further described below. In one embodiment, the key 208 moves from the off position to the on position by linear translation of the key within the opening 210. In the illustrated embodiment, the opening 210 is defined by an axis that is parallel to, and in fact coincident with, the transverse pivot axis 206 of the bail 202 (see FIG. 2).

When the key 208 is inserted and in the off position of FIG. 3, movement of the bail 202 between the inoperative and operative positions has no effect upon the implement or its operation. However, when the key is in the on position of FIG. 4, movement of the bail 202 from the inoperative to the operative positions results in actuation of the implement (e.g., delivery of power to the auger 106). Stated differently, the key 208 functions as both a conventional removable key, and also as a push button mechanism to provide dual actuation functionality for the control system 200.

Accordingly, to operate the implement, the key 208 may be inserted into the opening 210 of the housing 204 (see FIG. 2) until it locks in place in the off position shown in FIG. 3. Once again, with the key 208 inserted but in the off position, movement of the bail 202 has no effect on implement actuation.

When the operator wishes to energize the implement, the key 208 may be pushed inwardly (e.g., in the direction 212 as shown in FIG. 4) until it reaches the on position. Once the key is so positioned, movement of the bail 202 from the inoperative position (see FIG. 4) to the operative position as shown in FIG. 5 (e.g., movement of the bail in the direction 214 (see FIG. 4) toward the gripping area 118) will result in actuation of the implement (e.g., actuation of the snowthrower auger 106). As further explained below, once the bail 202 is in the operative position, the axial force applied to the key 208 to place the key in the on position may be released without affecting implement operation. However, once the bail 202 is returned to the inoperative position, subsequent actuation of the implement again requires both pressing of the key 208 and movement of the bail 202 as described above.

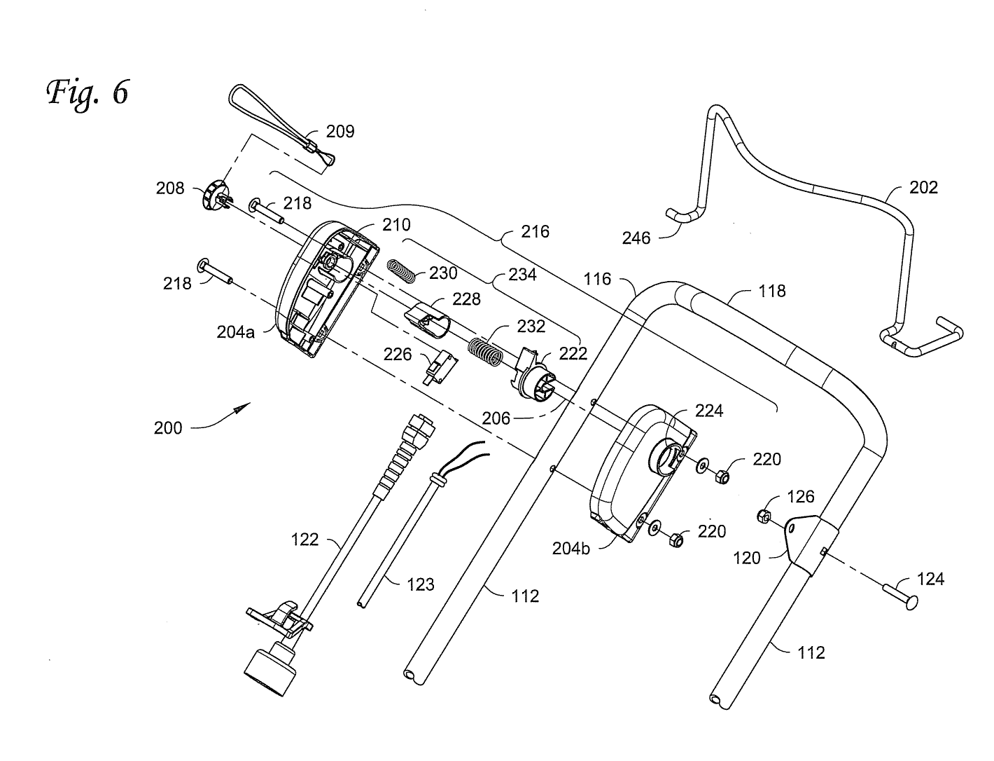

With this introduction to operation of the implement 100, an exemplary embodiment of the control system 200 will now be described. As shown in FIG. 6, the control housing 204 may be formed from two halves (204a, 204b) that together form an enclosure of a control module 216. The power cord 122, as well as control wiring 123 (to deliver power provided by the power cord to the implement), may also connect to the control housing as further described below. The halves 204a, 204b may be secured to one another, and to the handle 112, via fasteners 218 and nuts 220. The handle halves may also be secured to one another via fasteners (not shown) that extend through one half (e.g., half 204a) and thread to the other half (e.g., 204b). As is clear from the figures, the control housing 204 supports one side of the bail 202 for pivoting motion relative to the handle 112. An opposite side of the bail 202 may be pivotally supported to an opposite tube of the handle 112 with the bracket 120, which in the illustrated embodiment, is secured via fastener 124 and nut 126. The bracket 120 may, as shown in FIGS. 1-5, be mounted along an innermost (e.g., inboard) side of the appropriate handle tube 112 or alternatively, mounted along an outermost (e.g., outboard) side of the handle tube as shown in FIG. 6. In yet other embodiments, the bracket 120 may engage both inboard and outboard sides of the handle tube 112.

The control housing 204 defines a cavity that may contain various components of the control system 200. For instance, in the illustrated embodiment, an end 246 of the bail 202 is received within a pivot member 222, the latter of which rotates about the axis 206. To accommodate this rotation, the pivot member 222 may be constrained (journalled) for rotation-only movement by a sleeve portion 224 of the housing 204 (e.g., formed on the housing half 204b). A biasing member, e.g., bail spring 230, may bias the pivot member 222, and thus the bail 202, toward the inoperative position as further described below.

The control housing 204 may further contain or otherwise include a switch 226 and a switch actuator 228, both of which are described in more detail below. Another biasing member, e.g., actuator spring 232, may also be provided to bias the key 208 toward the off position (see FIG. 3), and the switch actuator 228 away from engagement with the pivot member 222. The pivot member 222, switch 226, switch actuator 228, springs 230 and 232, and related hardware may together define an actuation mechanism 234 of the control system 200. The actuation mechanism 234 may be associated with, and interact with, the key 208/bail 202 to provide the desired two-step actuation of the implement.

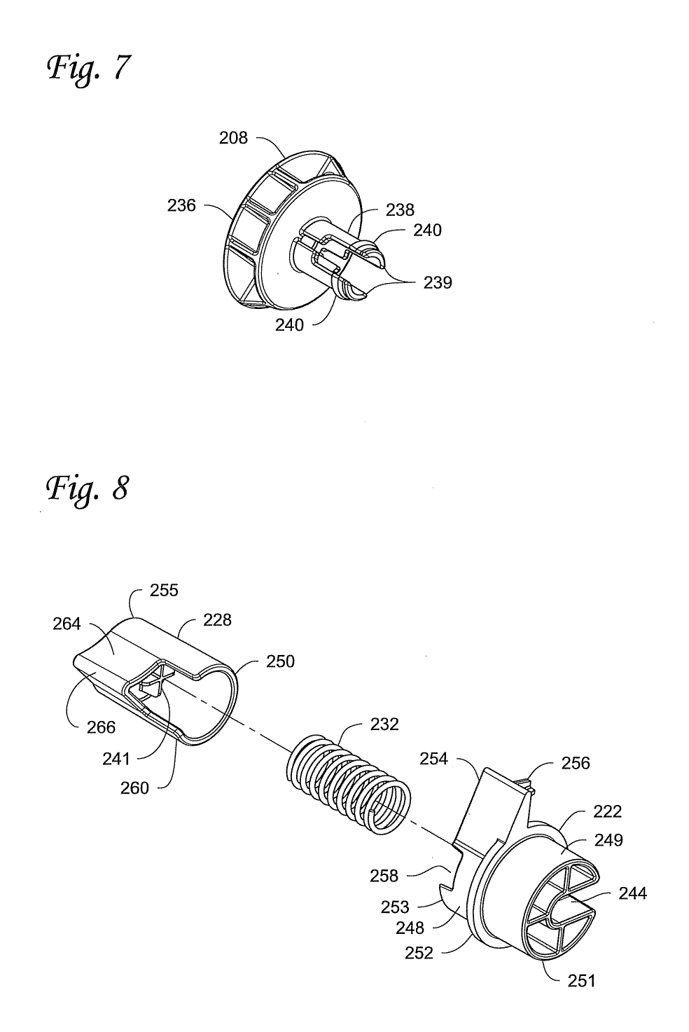

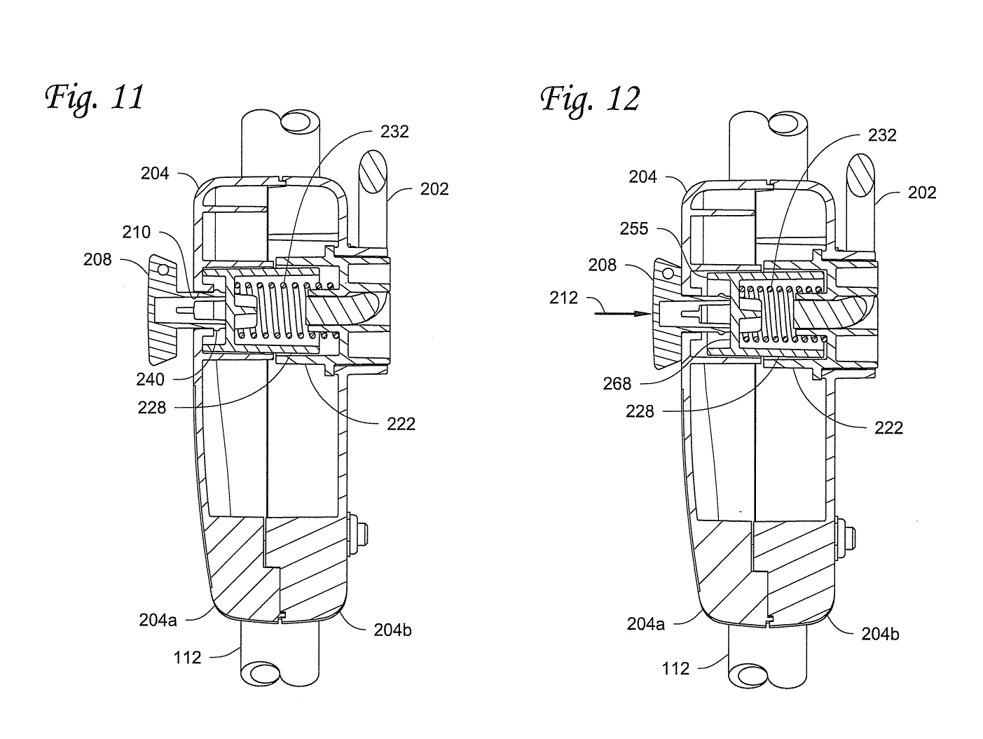

FIG. 7 is an enlarged view of the exemplary key 208 detached from the control housing 204. As shown in this view, the key may be configured with a button portion 236 for communication with a finger or hand of the operator, and an engagement portion 238. In one embodiment, the engagement portion 238 may be formed by a split cylinder forming two ears 239 each having a flange 240 formed thereon. By splitting the engagement portion into two separate ears 239 as shown, the ears may deflect as the key is inserted into the opening 210 of the housing until the flanges 240 move into the cavity formed by the housing. At this point, the ears 239 may return to their undeflected positions, effectively (but releasably) securing the key 208 within the opening 210 via the flange 240 as shown, for example, in FIG. 11.

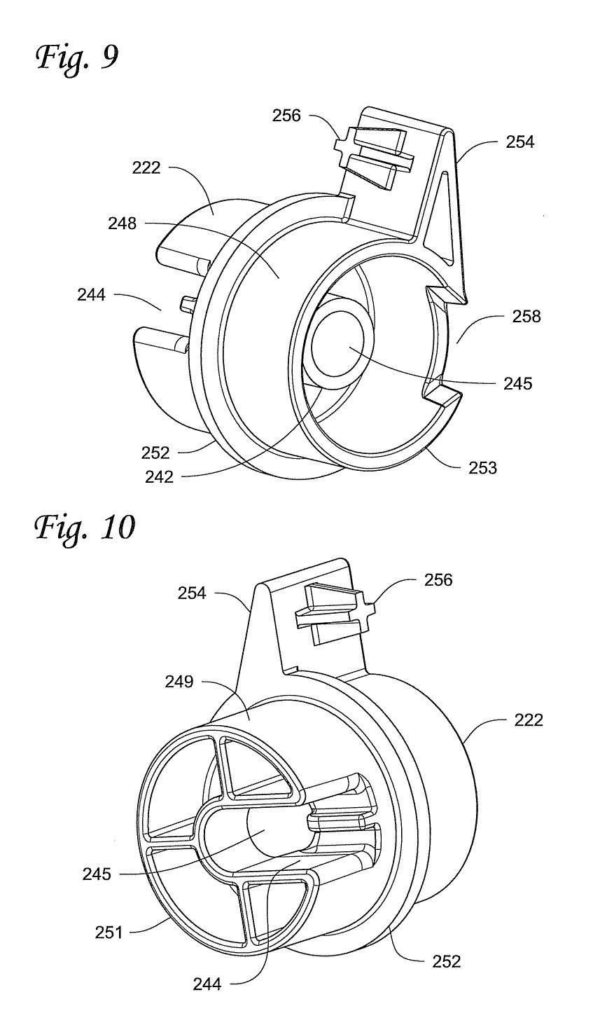

FIG. 8 is an exploded view the pivot member 222, switch actuator 228, and actuator spring 232, while FIGS. 9 and 10 are enlarged views of the pivot member only. As illustrated in these views, the actuator spring 232 may be configured as a compression spring that is positioned between first or adjacent ends or sides 253 and 250 of the pivot member 222 and the switch actuator 228, respectively, to bias these two members away from one another.

To contain the spring 232, the first or adjacent ends 253 and 250 of the pivot member 222 and the switch actuator 228, respectively, may include a spring post (242, 241) insertable into the actuator spring 232 during assembly. While the spring post 241 may be of most any construction, the spring post 242 on the pivot member 222 is, in one embodiment, tubular in shape as shown in FIG. 9 (e.g., it forms a passageway 245 extending entirely through the pivot member). The pivot member 222 may also include a radial groove 244 at its second end 251 (e.g., the end distal from the switch actuator 228) as shown in FIGS. 8 and 10. The radial groove 244 may communicate with the passageway 245 to accommodate a bend formed in the end 246 of the bail 202 (see FIG. 6).

The first end 253 of the pivot member 222 (e.g., the end adjacent the switch actuator 228) may define a tubular body 248 defining an annular region between the body 248 and the spring post 242 (see FIG. 9). The annular region may be configured to receive therein not only the actuator spring 232, but also the first end 250 (see FIG. 8) of the switch actuator 228.

The second end 251 of the pivot member 222 may further define a cylindrical body 249 configured to be journalled within the sleeve portion 224 (see, e.g., FIG. 6) of the housing 204. A flange 252 formed on the pivot member may, under biasing force of the actuator spring 232, bear against the housing 204 and prevent the pivot member from inadvertent axial movement.

As illustrated in FIG. 9, the pivot member 222 may further include a finger 254 extending radially from the tubular body 248. At a distal end of the finger, a spring post 256 may be provided to positively engage the bail spring 230 as further described below.

The pivot member 222 may further include a recess or cutout 258 formed at the first end 253 of the tubular body 248 as perhaps best shown in FIGS. 8 and 9.

As shown in FIG. 8, the switch actuator 228 may also form a generally cylindrical body 260 near its first end 250. The cylindrical body 260 may be sized to be received with clearance within the first end 253 of the pivot member 222 as generally indicated in FIG. 8 (see also FIGS. 11 and 12). A second end 255 of the switch actuator 228 may include a protruding ramp 264 that extends radially outward from the cylindrical body 260. The ramp 264 may define a caroming surface 266 that interacts with a paddle of the switch 226 (see FIG. 6) as further described below. The ramp 264 may be indexed to align with the cutout 258 of the pivot member 222 during assembly for reasons that will become clear.

When the key 208 is in the off position, the spring 232 may bias the switch actuator 228 away from the pivot member 222 (i.e., ensure that the ramp 264 is spaced-apart from, and not engaged with, the cutout 258) such that the two components may rotate independently of one another. However, as described below, when the key 208 is in the on position, the ramp 264 of the switch actuator may enter and engage the cutout 258 of the pivot member 222 such that the two components rotate as one when the bail is pivoted between the operative and inoperative positions. Stated alternatively, the switch actuator 228 may be operatively isolated from movement of the bail 202 when the key is in the off position, but operatively connected to the bail such that it pivots therewith when the key is in the on position.

FIG. 11 is a cross sectional view of the control housing 204 when the key 208 is inserted into the opening 210 but in the off position. As shown in this view, the actuator spring 232 biases the switch actuator 228 axially away from the pivot member 222. As a result, the protruding ramp 264 (see FIG. 8) is spaced-apart (e.g., along the pivot axis 206) from the cutout 258 such that movement of the bail 202 causes rotation of the pivot member 222 but not the switch actuator 228. As further shown in this figure, the flange 240 formed at the end of the key 208 may engage an inner surface of the control housing 204 to removably secure the key in place once it is inserted into the opening 210.

FIG. 12 is a view similar to that of FIG. 11, but with the key 208 displaced inwardly (e.g., in the direction 212) to the on position. As shown in this view, as the key is pressed inwardly, it pushes against a face 268 formed at or near the second end 255 of the switch actuator 228. Further pressing of the key 208 forces the actuator spring 232 to compress, allowing the switch actuator 228 to move toward the pivot member 222. As the switch actuator moves toward the pivot member, the protruding ramp 264 (see FIG. 8) of the switch actuator 228 may enter and operatively engage the cutout 258 of the pivot member 222 (e.g., the bail). As a result, subsequent pivoting of the bail 202 from the inoperative position (see FIG. 4) to the operative position (see FIG. 5) causes not just pivotal movement of the pivot member 222, but corresponding pivotal movement of the switch actuator 228 as well.

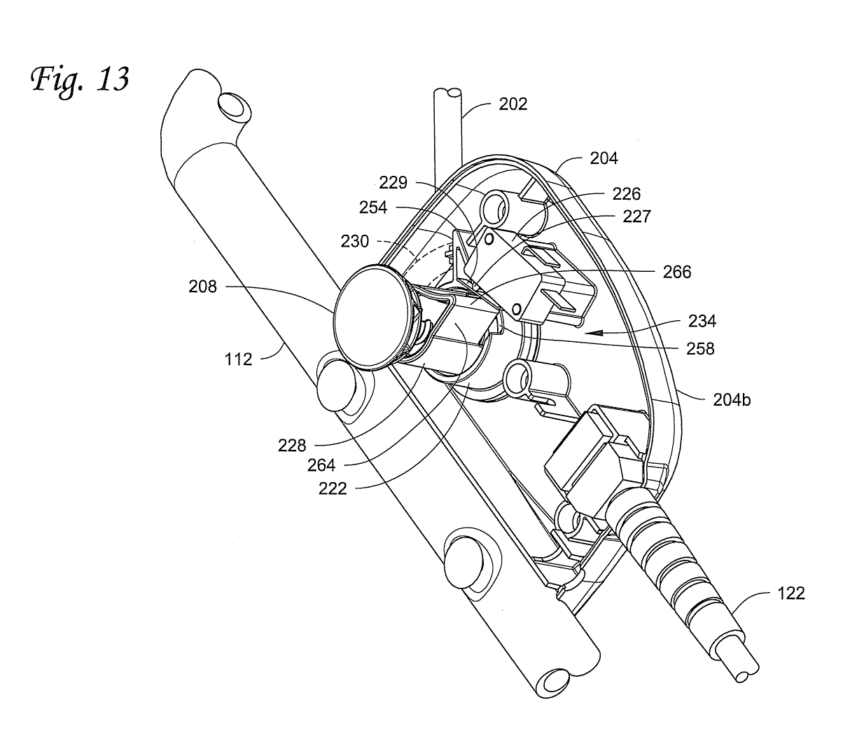

FIG. 13 is a perspective view of the control housing 204 with the half 204a removed to better illustrate internal structure. In this view, the control system 234 is shown as assembled and with the key 208 inserted into the control housing but in the off position. Moreover, the bail 202 is shown in the inoperative position. As shown in this view, the half 204b may include bosses for receiving threaded fasteners passing through the half 204a to hold the halves 204a, 204b together.

As illustrated in FIG. 13, the switch 226 may include a biased plunger 227 that, when depressed, closes internal circuitry within the switch. The switch 226 may further include a paddle 229 pivotally or flexibly attached to the switch body. The paddle 229 may, as further described below, when contacted by the caroming surface 266, depress the plunger 227 and close the switch.

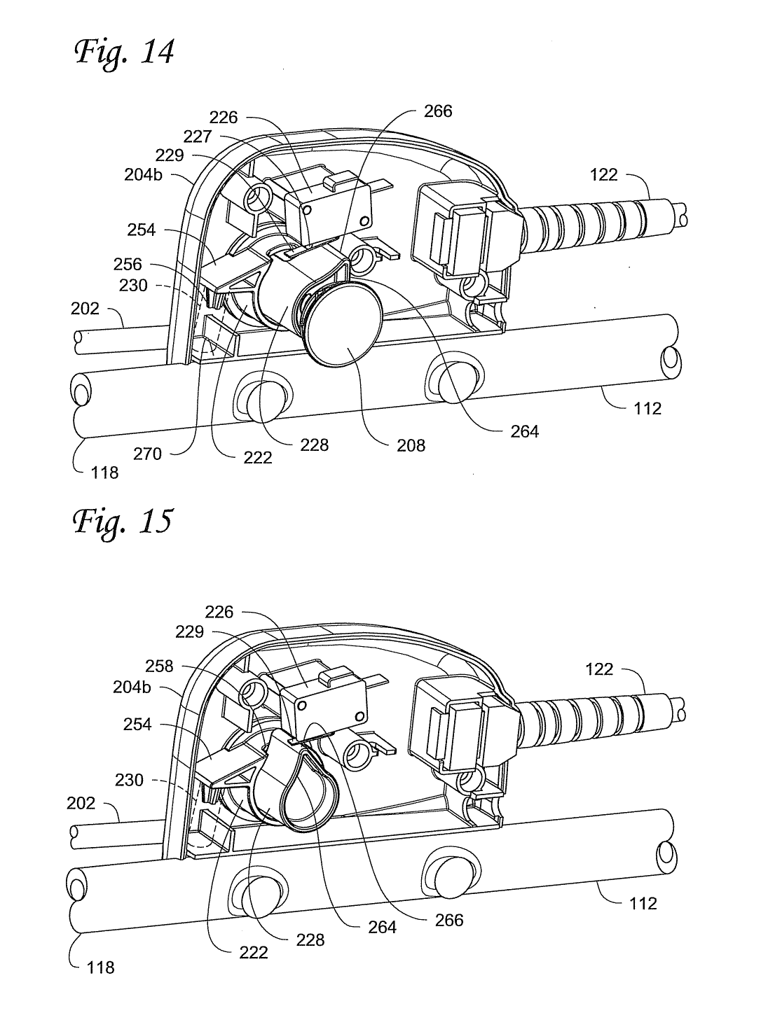

When the key 208 is on the off position as shown in FIG. 13, the protruding ramp 264 is spaced-apart from the cutout 258 such that the bail 202/pivot member 222 may pivot between the inoperative and operative positions without causing corresponding rotation of the switch actuator 228. FIG. 14 illustrates the control system when the key 208 is again in the off position and the bail is moved to the operative position. As shown, the bail 202/pivot member 222 may move to the operative position without affecting the position of the switch actuator 228. That is, the switch 226 (e.g., the switch plunger 227) may remain in its normally open state (corresponding to a de-energized state of the implement) even though the bail 202 is moved to the operative position. Similarly, if the bail 208 is moved to the operative position before the key 208 is moved to the on position, interference between the pivot member 222 and the switch actuator 228 may prevent subsequent movement of the key to the on position until the bail is first released. As a result, the operator must typically perform the correct actuation sequence in order to activate the implement.

FIG. 14 further illustrates the interaction of the bail spring 230 (shown diagrammatically in this and other figures) with the bail 202. In particular, in the illustrated embodiment, the bail spring 230 is contained between the spring post 256 (of the finger 254 of the pivot member 222) and a receiving surface 270 of the control housing 204 (e.g., of the half 204b). When the bail 202 is moved toward the operative position as shown in FIG. 14, the finger 254 causes the bail spring 230 to compress against the surface 270. Thus, when the bail is released, the bail spring 230 biases the pivot member 222 and bail 202 back toward the inoperative position (see FIG. 13).

FIG. 15 illustrates a view similar to FIG. 14, but shown as if the key 208 (removed from this view for clarity) were first depressed (e.g., moved to the on position) before the bail 202 was moved to the operative position. Accordingly, the protruding ramp 264 of the switch actuator 228 may enter and engage the cutout 258 of the pivot member 222 such that, when the bail 202/pivot member 222 rotates, the engagement of the ramp 264 with the cutout 258 causes the switch actuator 228 to correspondingly rotate.

As the switch actuator 228 rotates, the camming surface 266 of the protruding ramp 264 pushes against the paddle 229 of the switch 226, pushing the paddle, and thus the switch plunger 227 (see FIG. 14), upwardly (as viewed in FIGS. 14 and 15). Ultimately, the shape of the protruding ramp 264/camming surface 266 causes the paddle 229, once the bail reaches the operative position, to depress the plunger 227 sufficiently to manipulate or otherwise reconfigure the switch 226 to a closed stated corresponding to an energized state of the implement.

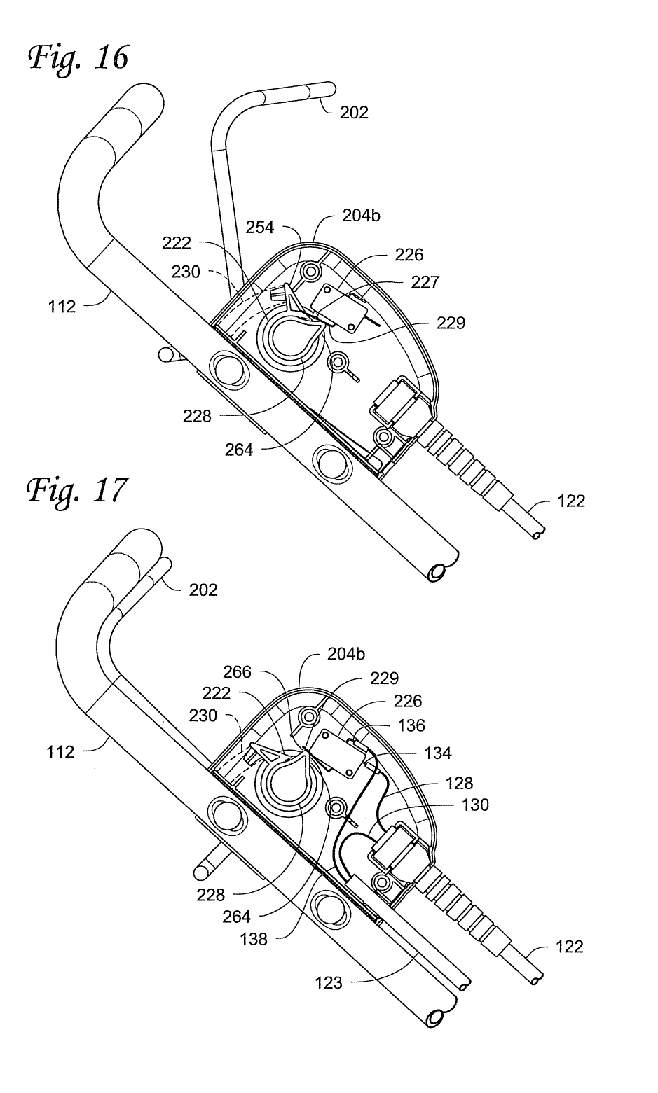

FIGS. 16 and 17 are side elevation views of the control housing 204 (with half 204a again removed) when the key 208 (not shown) is in the on position and the bail 202 in the inoperative position (FIG. 16) and in the operative position (FIG. 17). As shown in these views, with the bail 202 in the inoperative position, the protruding ramp 264 of the switch actuator 228 is positioned such that the paddle 229 is not depressing the plunger 227 of the switch 226 (see FIG. 16). However, as the bail 202 is rotated to the operative position of FIG. 17, the protruding ramp 264 correspondingly rotates. As the ramp 264 rotates, the camming surface 266 contacts the paddle 229. As the camming surface 266 of the protruding ramp 264 rides along the paddle 229, it forces the paddle toward the plunger 227 (see FIG. 16), causing the plunger to depress. Once the bail reaches the operative position of FIG. 17, the camming surface 266 causes the paddle 229 to adequately depress the plunger 227, resulting in closing of the switch circuit and thus delivery of power to the implement.

FIG. 17 further illustrates an electrical schematic of the switch 226 in accordance with one embodiment of the invention. The electric cord 122 may deliver AC power via two conductors 128 and 130. The conductor 130 may pass directly into a power delivery cord 123 that connects with the implement, while the conductor 128 may connect to a first terminal 134 on the switch 226. A second terminal 136 on the switch may connect to another conductor 138 that feeds the implement alongside the conductor 130.

As a result, when the plunger 227 of the switch 226 is depressed, the switching circuit within the switch is closed and current may flow from the conductor 128 to the conductor 138, thus providing power to the implement. However, when the plunger is not depressed, the switching circuit within the switch 226 is open and thus no current may flow (i.e., the connection between conductors 128 and 138 is broken).

Illustrative embodiments of this invention are described and reference has been made to possible variations within the scope of this invention. These and other variations, combinations, and modifications of the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

What is claimed is:

1. A power equipment unit comprising:
a ground-engaging implement;
a handle having a first end attached to the implement and a second end configured to cooperate with an operator;
a lever pivotally attached to the handle near the second end, the lever pivotable between an inoperative position and an operative position; and
a key removably receivable within an opening located proximate the second end of the handle, the key configured to move within, and along an axis of, the opening, between: an off position, wherein movement of the lever between the inoperative and operative position has no effect on the implement; and an on position, wherein movement of the lever between the inoperative and operative position results in actuation of the implement.

2. The unit of claim 1, further comprising a control housing configured to receive both the key and a portion of the lever.

3. The unit of claim 1, further comprising a biasing member configured to bias the lever toward the inoperative position.

4. The unit of claim 1, further comprising a biasing member configured to bias the key toward the off position.

5. The unit of claim 1, further comprising a switch actuator that is, when the key is in the on position, configured to operatively engage the lever and pivot therewith.

6. The unit of claim 5, further comprising a switch associated with the lever, wherein the switch actuator is configured to close the switch when the key is in the on position and the lever is in the operative position.

7. A power equipment unit comprising:
a ground-engaging implement;
a handle having a first end attached to the implement and a second end configured to cooperate with an operator;
a control housing attached to the handle near the second end, the control housing comprising a switch selectively configurable between: a normally open state corresponding to a de-energized state of the implement; and a closed state corresponding to an energized state of the implement;
a lever pivotally attached to the handle near the second end, the lever pivotable between at least an inoperative position and an operative position; and
a removable key configured to be positioned within an opening of the control housing, the key configured to move within, and along an axis of, the opening, between: an off position, wherein movement of the lever from the inoperative position to the operative position has no effect on the switch; and an on position, wherein movement of the lever from the inoperative position to operative position results in manipulation of the switch from the open state to the closed state.

8. The unit of claim 7, wherein the axis of the opening is parallel to a pivot axis of the lever.

9. The unit of claim 7, wherein the lever is pivotally attached to the control housing.

10. The unit of claim 7, further comprising a switch actuator associated with the key, wherein the switch actuator is: operatively isolated from movement of the lever when the key is in the off position; and operatively connected to the lever such that the switch actuator pivots with the lever when the key is in the on position.

11. The unit of claim 10, further comprising a pivot member attached to the lever, the switch actuator configured to engage the pivot member when the key is in the on position.

12. The unit of claim 11, further comprising a biasing member configured to bias the switch actuator away from engagement with the pivot member.

13. The unit of claim 11, wherein the switch actuator comprises a radially protruding ramp, the ramp configured to engage a cutout formed in a portion of the pivot member when the key is in the on position.

14. The unit of claim 7, wherein the implement is an electric snowthrower.

15. The unit of claim 7, wherein the implement is an electric lawn mower.

16. The unit of claim 7, wherein the lever comprises a bail configured to pivot about a horizontal axis that is transverse to a direction of implement travel.

17. A power equipment unit comprising:
an electrically powered, ground-engaging implement;
a handle having a first end attached to the implement and a second end configured to cooperate with an operator;
a control housing attached to the handle near the second end, the control housing comprising a switch selectively configurable between: a normally open state corresponding to a de-energized state of the implement; and a closed state corresponding to an energized state of the implement;
a lever pivotally attached to one or both of the handle and the control housing, the lever pivotable between an inoperative position and an operative position; and
a removable key configured to be positioned within an opening of the control housing, the key configured to move within, and along an axis of, the opening between: an off position, wherein movement of the lever from the inoperative position to the operative position is isolated from the switch; and an on position, wherein movement of the lever from the inoperative position to the operative position results in manipulation of the switch from the open state to the closed state.

18. The unit of claim 17, further comprising:
a pivot member secured to a portion of the lever, the pivot member journalled within the control housing;
a switch actuator contained within the control housing, the switch actuator movable toward the pivot member when the key is moved from the off position to the on position; and
a biasing member configured to move the switch actuator away from the pivot member when the key is in the off position.

19. The unit of claim 18, wherein the switch actuator comprises a radially protruding ramp, the ramp configured to engage a cutout formed in a portion of the pivot member when the key is in the on position.

20. The unit of claim 18, wherein, when the key is in the on position, the switch actuator is configured to engage the pivot member such that the switch actuator moves with the pivot member.
